(19) United States
(12) Patent Application Publication
(10) Pub. No.: US 2013/0303071 A1
(43) Pub. Date: Nov. 14, 2013

(54) AIR FEED STRUCTURE FOR VEHICLE

(71) Applicant: SUZUKI MOTOR CORPORATION, Shizuoka-ken (JP)

(72) Inventor: Kazuhiko Seki, Shizuoka-ken (JP)

(73) Assignee: Suzuki Motor Corporation, Shizuoka-ken (JP)

(21) Appl. No.: 13/799,634

(22) Filed: Mar. 13, 2013

(30) Foreign Application Priority Data
May 9, 2012 (JP) 2012-107267

(51) Int. Cl. B60H 1/34

(52) U.S. Cl. CPC B60H 1/3421
USPC 454/155

(57) ABSTRACT

An air blowing portion 7 for blowing air flowing in an air feed duct 9 into a vehicle compartment is provided with a plurality of lateral fins 11, and the air blowing portion 7 is provided with a longitudinal fin 12, and the longitudinal fin 12 is inclined in such a way that as a portion is closer to a downstream side, the portion is positioned closer to a one side portion 11S1 side of the lateral fin 11, and a convex portion 14 protrudes into a flow passage of the air from a one side portion 9S1 side of the air feed duct 9 on an upstream side of the longitudinal fin 12.

### RELATED APPLICATION

This application claims priority from Japanese Patent Application No. 2012-107267, filed May 9, 2012, the disclosure of which is incorporated by reference herein in its entirety.

### FIELD AND BACKGROUND OF THE INVENTION

The present invention relates to an air feed structure of a vehicle in which an air blowing portion for blowing air flowing in an air feed duct into a vehicle compartment is provided with a plurality of lateral fins.

An instrument panel has an air blowing portion of an air conditioner provided in a side portion thereof, the air blowing portion defogging a front window glass and a side window glass.

In order to defog these window glasses, air must be blown in a plurality of directions to the front window glass and the side window glass from the air blowing portion.

As a solution to this end, there is proposed a solution of providing a plurality of air blowing portions for blowing air in a plurality of directions respectively and of providing each of the air blowing portions with a fin and a duct. However, according to this solution, the number of parts will be increased.

Hence, a technology disclosed in Japanese Publication No. 2598089 has been developed. In this technology, an air blowing port formed at one air blowing portion is divided into an upper air blowing port and a lower air blowing port by a partition plate.

The technology is constructed in such a way that air is blown to a corner of a front window glass from the upper air blowing port via a plurality of first lateral fins and that the air is blown to the side window glass from the lower air blowing port via a plurality of second lateral fins.

### SUMMARY OF THE INVENTION

According to the structure in the related art, parts of fins and the like need to be disposed respectively at the upper air blowing port and the lower blowing port, so that the number of parts cannot be sufficiently decreased. Furthermore, the air blowing portion is increased in size, which therefore makes it difficult to dispose the air blowing portion in a narrow space.

An object of the present invention is to provide an air feed structure of a vehicle that can blow air in a plurality of directions but has fewer parts and can have a smaller air blowing portion and can also have the air blowing portion disposed in a narrow space.

The present invention is an air feed structure for a vehicle in which an air blowing portion for blowing air flowing in an air feed duct into a vehicle compartment is provided with a plurality of lateral fins, and the present invention is characterized in that:

the air blowing portion is provided with a longitudinal fin;

the longitudinal fin is inclined in such a way that as a portion is closer to a downstream side, the portion is positioned closer to a one side portion side of the lateral fins; and

a convex portion protrudes into a flow passage of the air from a one side portion side of the air feed duct on an upstream side of the longitudinal fin or from a one side portion side of the air blowing portion on the upstream side of the longitudinal fin.

According to this construction, the longitudinal fin is inclined in such a way that as the portion is closer to the downstream side, the portion is positioned closer to the one side portion side of the lateral fins. Hence, the air fed from the air feed duct and impinging on the longitudinal fin flows along the longitudinal fin in such a way that as the air is closer to the downstream side, the air is positioned closer to the one side portion side of the lateral fins. In other words, the air impinging on the longitudinal fin flows in an inclined direction with respect to a direction of the flow of the air on the upstream side of the longitudinal fin (hereinafter referred to as “straight direction”).

In this case, a structure for only impinging the air fed from the air feed duct on the longitudinal fin cannot keep the flow of the air in the inclined direction. That is, the air just after passing an end edge on the downstream side of the longitudinal fin is attracted by the air flowing between the one side portions of the lateral fins and the end edge on the downstream side of the longitudinal fin, thereby flowing again in the straight direction by the Coanda effect.

However, according to the construction of the present invention, the convex portion brings the air into a turbulent flow and the air brought into the turbulent flow impinges on the longitudinal fin. In this way, the air passing straight between the one side portions of the lateral fins and the end edge on the downstream side of the longitudinal fin can be decreased and the air impinging on the longitudinal fin can be increased.

Therefore, it is possible to prevent the Coanda effect and to have the air impinge on the longitudinal fin flow in the inclined direction also after the air passes the end edge on the downstream side of the longitudinal fin.

On the other hand, the air, which is fed from the air feed duct and does not impinge on the longitudinal fin of the air blowing portion but is made to flow around the longitudinal fin, is guided by the lateral fins and is made to flow in the straight direction. The air flowing in this way includes the air flowing between other side portions of the lateral fins and an end edge on the upstream side of the longitudinal fin.

As described above, according to the construction of the present invention, even a structure provided with the single air blowing port can make the air fed to the air blowing portion from the air feed duct flow in two directions of the inclined direction and the straight direction.

Hence, as compared to a structure in which air is blown in two directions from two air blowing ports, the parts of the first air blowing portion can be reduced in size and in number and the air blowing portion can be reduced in size. Furthermore, an installation space can be reduced and the air blowing portion can be disposed also in a narrow space.

In the present invention, if a tip in a direction in which the convex portion protrudes, when viewed from the direction of the flow of the air, overlaps the longitudinal fin, the following effect can be produced.

The air brought into the turbulent flow by the convex portion can be easily impinge on the longitudinal fin, and the air passing straight between the one side portions of the lateral fins and the end edge on the downstream side of the longitudinal fin can be reduced and the air impinging on the longitudinal fin can be increased.

In this way, the Coanda effect can be prevented and the air impinging on the longitudinal fin can be made to flow in the inclined direction also after the air passes the end edge on the downstream side of the longitudinal fin.

In the present invention, when the convex portion is formed by making a side wall of the air feed duct concave to an inside of the flow passage, the following effect can be produced.

Generally, the air feed duct is formed of resin. According to the construction described above, the convex portion can be formed on the air feed duct without increasing thickness, so that a change in dimension is unlikely to occur due to shrinkage of the resin, thereby preventing forming errors and also increase in weight of the air feed duct.

In the present invention, when the longitudinal fin is formed integrally with a pair of lateral fins adjacent to each other above and below in such a way as to couple the pair of lateral fins, the following effect can be produced.

The rigidities of the lateral fins can be improved.

In the present invention, when the air blowing portion is disposed at a side portion of an instrument panel and a fixing portion, which is to be fixed to a fixed portion disposed at the instrument panel, is disposed at a periphery of the convex portion of the air feed duct, the following effect can be produced.

The fixing portion is disposed at the periphery of the convex portion of the air feed duct, so that the convex portion produces a bead effect for the fixing portion to thereby improve the rigidity of the fixing portion. This can improve the fixing strength of the fixing portion.

Hence, even if the air feed duct is easily bent and deformed, the air feed duct can improve the direction and the positional accuracy to the longitudinal fin. As a result, the turbulent flow impinging on the longitudinal fin can be correctly produced by the convex portion.

According to the present invention, it is possible to provide an air feed structure of a vehicle that can blow air in a plurality of directions but has fewer parts and has a smaller air blowing portion, and the air blowing portion can also be disposed in a narrow space.

### BRIEF DESCRIPTION OF DRAWINGS

FIG. 1 is a perspective view showing a front side portion in a vehicle compartment.

FIG. 2 is a perspective view of an air blowing portion.

FIG. 3 is a perspective view showing an air blowing portion and a downstream portion of an air feed duct.

FIG. 4(a) is a section view to show a flow of air in an air feed duct and in an air blowing portion and FIG. 4(b) is a section view of a comparative example corresponding to FIG. 4(a).

FIG. 5 is a perspective view showing an air feed duct and an air blowing portion which communicates and connects with this air feed duct.

### DESCRIPTION OF THE EMBODIMENTS OF THE INVENTION

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. Unless otherwise defined, all technical and scientific terms used herein have the same meaning as commonly understood by one of ordinary skill in the art to which this invention belongs. All references cited are incorporated herein by reference in their entirety.

Hereinafter, an embodiment for carrying out the present invention will be described based on the figures.

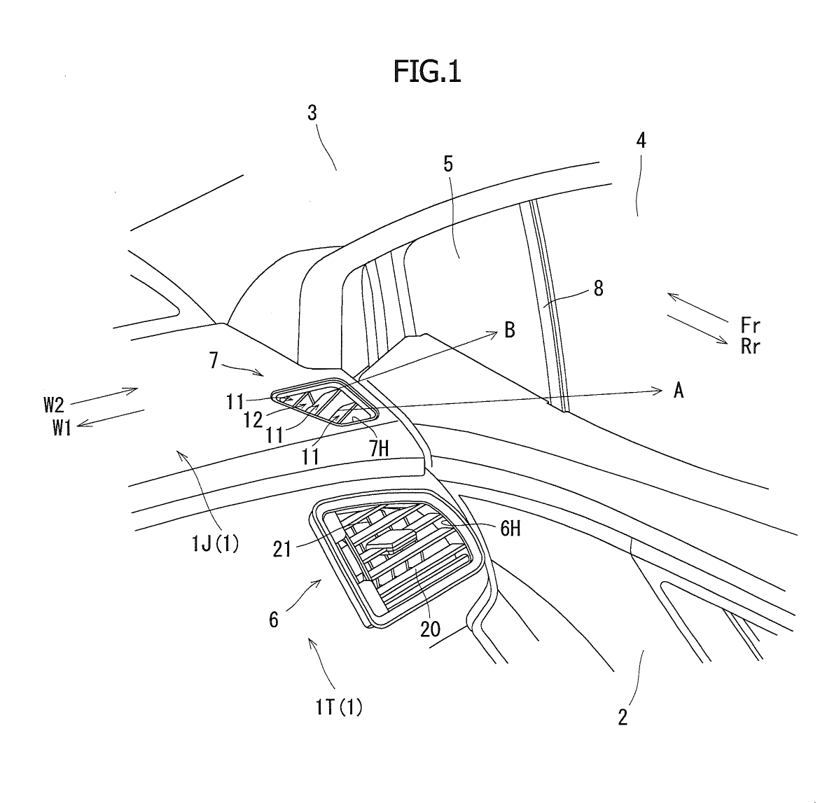

As shown in FIG. 1, a front side door 2 of an automobile is provided with a side window glass 4 freely moved up and down and a front window glass 5 as a visual small window of a fixed type. The front window glass 5 is positioned on a vehicle front side Fr of the side window glass 4 and is positioned on a side of an instrument panel 1.

A sash 8 extending in a vertical direction is provided between the side window glass 4 and the front window glass 5. The sash 8 becomes a guide rail when the side window glass 4 is moved up and down. A reference sign 3 designates a front pillar inclined upward toward the rear.

A first air blowing portion 7 for blowing air flowing in an air feed duct 9 into a vehicle compartment is provided on a side portion of an upper wall 1J of the instrument panel 1. Furthermore, a second air blowing portion 6 for blowing the air flowing in the air feed duct 9 into the vehicle compartment is provided on a side portion of a vertical wall 1T of the instrument panel 1.

The air feed duct 9 has the air fed thereinto from an air conditioner, the air having temperature conditioned by the air conditioner. The first air blowing portion 7 blows the air on a corner portion in the lower front of the side window glass 4 and on a corner portion in the lower rear of the front window glass 5 to thereby defog the respective window glasses. The second air blowing portion 6 blows the air on a central side in a longitudinal direction of the vehicle in the vehicle compartment.

The air conditioner, the air feed duct 9, the first air blowing portion 7, and the second air blowing portion 6 construct an air feed structure of the vehicle. The air feed duct 9, the first air blowing portion 7, and the second air blowing portion 6 are formed of resin.

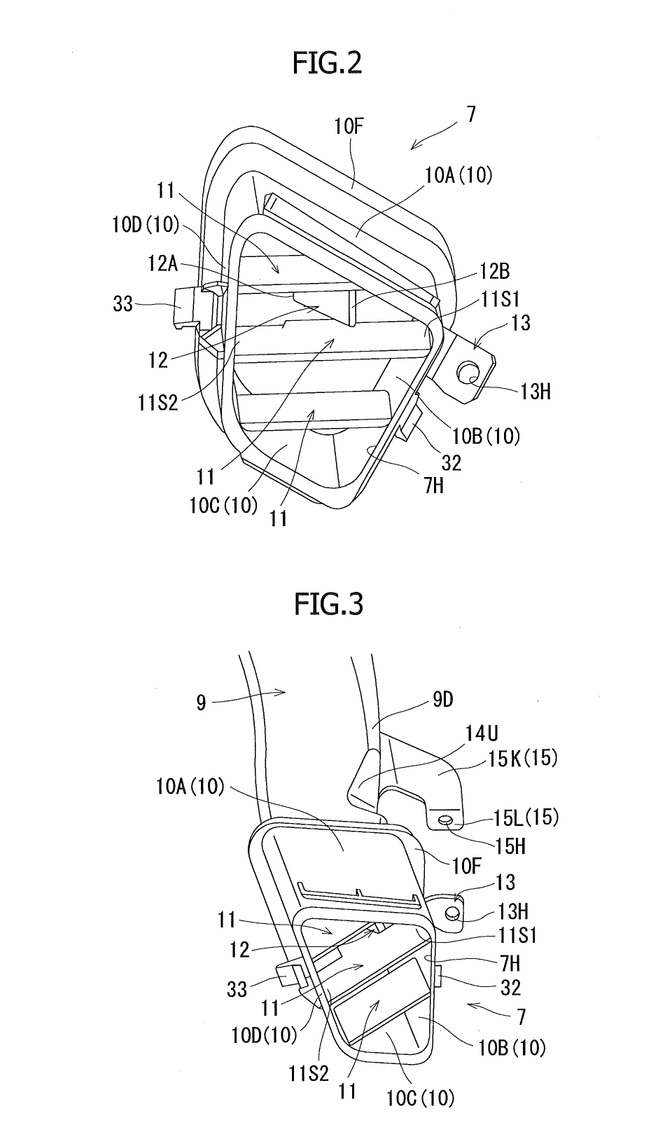

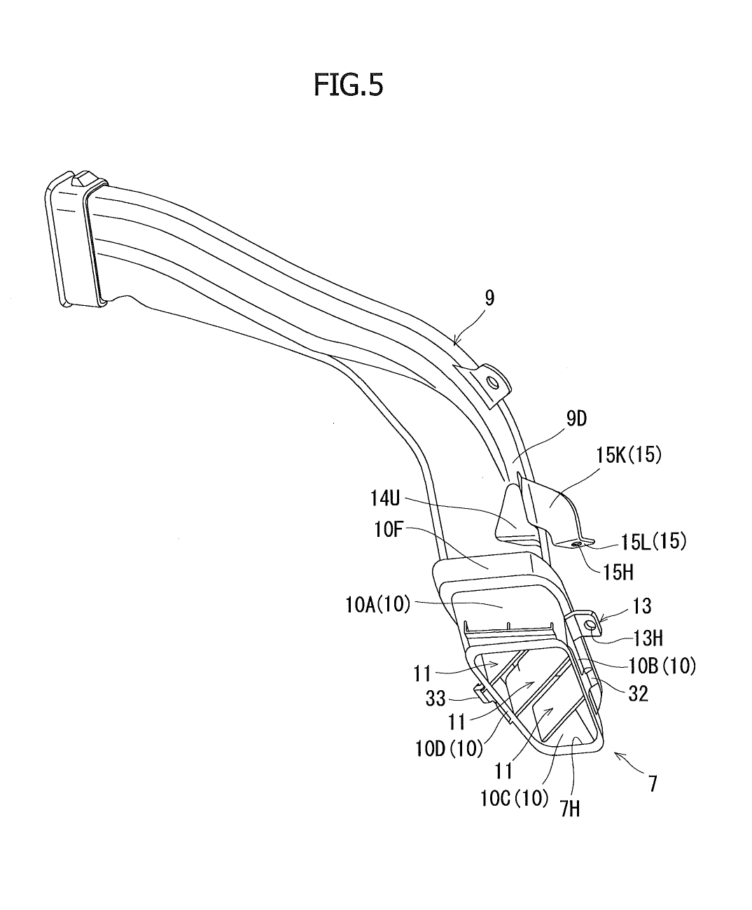

As shown in FIG. 2, FIG. 3, and FIG. 5, the first air blowing portion 7 is provided with an angular cylindrical peripheral wall 10 having a trapezoidal section. Of a first wall portion 10A to a fourth wall portion 10D of the peripheral wall 10 corresponding to the respective sides of the trapezoidal section, wall portions adjacent to each other of the first wall portion 10A to the third wall portion 10C which are continuous with each other are positioned at right angles to each other. The first wall portion 10A and the third wall portion 10C are positioned parallel to each other. The first wall portion 10A is set longer than the third wall portion 10C in the section, and the fourth wall portion 10D for coupling an end portion of the first wall portion 10A to an end portion of the third wall portion 10C is inclined.

The second wall portion 10B is provided with a coupling piece 13 for a fixed portion (not shown) of the instrument panel 1 and a first engaging claw 32 for a first engaged part of the instrument panel 1. In the coupling piece 13 is formed a through hole 13H through which a fastening member is passed. Furthermore, the fourth wall portion 10D is provided with a second engaging claw 33 for a second engaged part (not shown) of the instrument panel 1.

As shown in FIG. 1, FIG. 3, and FIG. 5, in a state in which the peripheral wall 10 is fixed to the instrument panel 1, the first wall portion 10A and the third wall portion 10C extend in a width direction of the vehicle and the first wall portion 10A is positioned closer to the vehicle front side Fr than the third wall portion 10C. Furthermore, the second wall portion 10B is positioned closer to an outside W2 in the width direction of the vehicle than the fourth wall portion 10D and is extended along the longitudinal direction of the vehicle. The fourth wall portion 10D is inclined in such a way that as a portion is closer to the vehicle front side Fr, the portion is positioned closer to an inside W1 in the width direction of the vehicle.

As shown in FIG. 5, an end portion 10F on an upstream side of the peripheral wall 10 has an expanded diameter and communicates and connects with an end portion on a downstream side of the air feed duct 9. An end portion on the downstream side of the peripheral wall 10 is open upward (see FIG. 1) and this opening is constructed in an air blowing port 7H. The air blowing port 7H is called a demister opening portion.

A plurality of (in the present embodiment, three) lateral fins 11 parallel to each other are set between inner peripheral faces of the peripheral wall 10. Each of the plurality of lateral fins 11 is formed in the shape of a rectangular plate elongated in a direction perpendicular to the flow of the air. Furthermore, the lateral fins 11 are inclined in such a way that as their portions are closer to the inner side W1 in the direction of the vehicle, the portions are positioned closer to a vehicle rear side Rr and in such a way that as their portions are closer to the downstream side, the portions are positioned at upper positions.

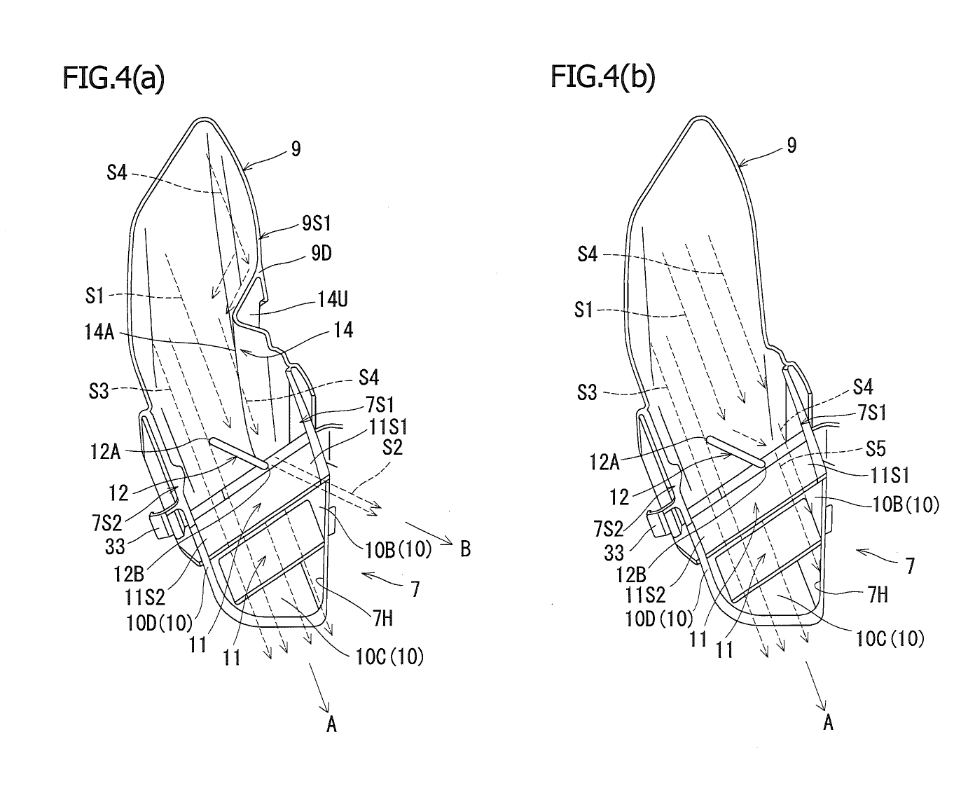

As shown in FIG. 2 and FIG. 4(a), a longitudinal fin 12 for coupling a pair of upper lateral fins 11, which are adjacent to each other above and below of the three lateral fins 11, is formed integrally with the pair of lateral fins 11. The lateral fins 11 are perpendicular to the longitudinal fin 12. The longitudinal fin 12 is formed in the shape of a rectangular plate and is inclined in such a way that as a portion is closer to the downstream side of a flow passage of the air, the portion is positioned closer to a one side portion 11S1 side of the lateral fins 11.

In addition, the longitudinal fin 12 has its nearly entire upper end edge connected to a lower face of the upper lateral fin 11. Furthermore, a lower end edge portion on the downstream side of the longitudinal fin 12 is connected to an upper face of the lower lateral fin 11, and a remaining lower end edge portion of the longitudinal fin 12 protrudes to the upstream side from the upstream side of the lower lateral fin 11 and is exposed (see FIG. 2).

Furthermore, a convex portion 14 having a triangular section protrudes in the flow passage of the air from a one side portion 9S1 side of the air feed duct 9 on the upstream side of the longitudinal fin 12. The convex portion 14 is formed by making a side wall 9D of the air feed duct 9 concave to the inside of the flow passage of the air. Reference signs 14U in FIG. 3, FIG. 4(a), and FIG. 5 show a reverse face of the convex portion 14.

As shown in FIG. 3 and FIG. 5, a fixing bracket 15 (corresponding to a fixing portion), which is to be fixed to a fixed portion (not shown) of the instrument panel 1, is formed integrally with a peripheral portion of the convex portion 14 of the air feed duct 9. The fixing bracket 15 is constructed of: a plate-shaped leg portion 15K rising from the side wall 9D of the air feed duct 9 near the reverse face 14U of the convex portion 14; and a fixing piece 15L bent to the leg portion 15K. The fixing piece 15L is positioned outside the reverse face 14U of the convex portion 14, and a through hole through which a fastening member is passed is formed in the fixing piece 15L.

When viewed from a direction of the flow of the air, a tip 14A in a direction in which the convex portion 14 protrudes overlaps the longitudinal fin 12. In the present embodiment, when viewed from the direction of the flow of the air, the tip 14A in the direction in which the convex portion 14 protrudes nearly coincides with an end edge 12B on the downstream side of the longitudinal fin 12. When viewed from the direction of the flow of the air, the tip 14A may be positioned closer to a central side of the longitudinal fin 12 than the end edge 12B on the downstream side of the longitudinal fin 12.

As shown in FIG. 1, the second air blowing portion 6 is provided with a plurality of lateral fins 20 arranged above and below and a plurality of longitudinal fins 21 positioned on the upstream side of these lateral fins 20. An air blowing port 6H is directed to the vehicle rear side Rr. According to the construction of the present invention, the following effects can be produced.

(1) As shown in FIG. 4(a), the longitudinal fin 12 of the first air blowing portion 7 is inclined in such a way that as the portion is closer to the downstream side, the portion is positioned closer to the one side portion 11S1 side of the lateral fins 11. Hence, the air S2 fed from the air feed duct 9 and impinging on the longitudinal fin 12 flows along the longitudinal fin 12 in such a way that the air is closer to the downstream side, and the air is positioned closer to the one side portion 11S1 side of the lateral fins 11. In other words, the air S2 impinging on the longitudinal fin 12 flows in an inclined direction B with respect to a direction A of the flow of the air Si on the upstream side of the longitudinal fin 12 (hereinafter referred to as “straight direction”).

In this case, a structure for only impinging the air fed from the air feed duct 9 on the longitudinal fin 12 (structure not having the convex portion 14) cannot keep the flow of the air in the inclined direction B (direction along the longitudinal fin 12). That is, as shown by a structure of a comparative example, shown in FIG. 4(b), which is not provided with the convex portion 14, the air S5 just after passing the end edge 12B on the downstream side of the longitudinal fin 12 is attracted by the air S4 flowing between the one side portions 11S1 of the lateral fins 11 and the end edge 12B on the downstream side of the longitudinal fin 12, thereby flowing again in the straight direction A by the Coanda effect.

However, according to the construction of the present invention, as shown in FIG. 4(a), the convex portion 14 brings the air S4 into a turbulent flow and the air S4 brought into the turbulent flow impinges on the longitudinal fin 12. In this way, the air passing straight between the one side portions 11S1 of the lateral fins 11 and the end edge 12B on the downstream side of the longitudinal fin 12 can be decreased and the air S1, S4 impinge on the longitudinal fin 12 can be increased.

Therefore, it is possible to prevent the Coanda effect and to make the air S1, S4 impinge on the longitudinal fin 12 flow in the inclined direction B also after the air S1, S4 pass the end edge 12B on the downstream side of the longitudinal fin 12. The air S2 flowing in the inclined direction B is blown on the corner portion in the lower rear of the front window glass 5 (see also FIG. 1).

On the other hand, the air S3, which is fed from the air feed duct 9 and does not impinge on the longitudinal fin 12 of the first air blowing portion 7 but is made to flow around the longitudinal fin 12, is guided by the lateral fins 11 and is made to flow in the straight direction A. The air flowing in this way includes the air S3 flowing between other side portions 11S2 of the lateral fins 11 and an end edge 12A on the upstream side of the longitudinal fin 12. The air S3 flowing in the straight direction A is blown on the corner portion in the lower front of the side window glass 4 (see also FIG. 1).

As described above, according to the construction of the present invention, even the structure provided with the single air blowing port 7H can make the air S1, S3, and S4 fed to the first air blowing portion 7 from the air feed duct 9 flow in two directions of the inclined direction B and the straight direction A.

Hence, as compared to a structure in which the air is blown in two directions A, B from two air blowing ports, the parts of the first air blowing portion 7 can be reduced in size and in number and the first air blowing portion 7 can be reduced in size. Furthermore, an installation space can be reduced and the first air blowing portion 7 can be disposed also in a narrow space.

(2) When viewed from the direction of the flow of the air, the tip 14A in the direction in which the convex portion 14 protrudes overlaps the longitudinal fin 12, so that the air brought into the turbulent flow by the convex portion 14 can be easily impinge on the longitudinal fin 12. The air passing straight between the one side portions 11S1 of the lateral fins 11 and the end edge 12B on the downstream side of the longitudinal fin 12 can be more reduced and the air impinging on the longitudinal fin 12 can be increased.

This can prevent the Coanda effect and can make the air impinging on the longitudinal fin 12 flow in the inclined direction B also after the air passes the end edge 12B on the downstream side of the longitudinal fin 12.

(3) The convex portion 14 is formed by making the side wall 9D of the air feed duct 9 concave to an inside of the flow passage, so that the convex portion 14 can be formed without increasing thickness and a change in dimension is unlikely to occur due to shrinkage of resin, which can prevent incorrect formation and also increase in the weight of the air feed duct 9.

(4) The longitudinal fin 12 is formed integrally with the pair of lateral fins 11 adjacent to each other above and below in such a way as to couple the pair of lateral fins 11, whereby the rigidities of the lateral fins 11 can be improved.

(5) The fixing bracket 15 is disposed at the periphery of the convex portion 14 of the air feed duct 9, so that the convex portion 14 produces a bead effect for the fixing bracket 15 to thereby improve the rigidity of the fixing bracket 15. This can improve the fixing strength of the fixing bracket 15.

Hence, even if the air feed duct 9 is easily bent and deformed, the air feed duct 9 can improve the direction and the positional accuracy of the convex portion 14 to the longitudinal fin 12. As a result, the turbulent flow impinges on the longitudinal fin 12 can be correctly produced by the convex portion 14.

(1) The convex portion 14 may be protruded into the flow passage of the air from a one side portion 7S1 side of the first air blowing portion 7 on the upstream side of the longitudinal fin 12.

(2) In the embodiment described above, the longitudinal fin 12 is arranged in such a way as to couple two upper lateral fins 11 of three lateral fins 11, but the longitudinal fin 12 may be arranged in such a way as to couple two lower lateral fins 11.

(3) The convex portion 14 may be formed in a raised shape in such a way as to increase the thickness of a portion of the wall portion of the air feed duct 9.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed:

1. An air feed structure of a vehicle in which an air blowing portion for blowing air flowing in an air feed duct into a vehicle compartment is provided with a plurality of lateral fins,
wherein said air blowing portion is provided with a longitudinal fin,
wherein said longitudinal fin is inclined in such a way that as a portion is closer to a downstream side, said portion is positioned closer to a one side portion side of said lateral fins, and
wherein a convex portion protrudes into a flow passage of said air from a one side portion side of said air feed duct on an upstream side of said longitudinal fin or from a one side portion side of said air blowing portion on said upstream side of said longitudinal fin.

2. An air feed structure according to claim 1,
wherein a tip in a direction in which said convex portion protrudes, when viewed from a direction of flow of said air, overlaps said longitudinal fin.

3. An air feed structure according to claim 1,
wherein said convex portion is formed by making a side wall of said air feed duct concave to an inside of said flow passage.

4. An air feed structure according to claim 1,
wherein said longitudinal fin is formed integrally with a pair of lateral fins adjacent to each other above and below in such a way as to couple said pair of lateral fins.

5. An air feed structure according to claim 1,
wherein said air blowing portion is disposed at a side portion of an instrument panel, and
wherein a fixing portion, which is to be fixed to a fixed portion disposed at said instrument panel, is disposed at a periphery of said convex portion of said air feed duct.

6. An air feed structure according to claim 2,
wherein said convex portion is formed by making a side wall of said air feed duct concave to an inside of said flow passage.

7. An air feed structure according to claim 2,
wherein said longitudinal fin is formed integrally with a pair of lateral fins adjacent to each other above and below in such a way as to couple said pair of lateral fins.

8. An air feed structure according to claim 2,
wherein said air blowing portion is disposed at a side portion of an instrument panel, and
wherein a fixing portion, which is to be fixed to a fixed portion disposed at said instrument panel, is disposed at a periphery of said convex portion of said air feed duct.

9. An air feed structure according to claim 3,
wherein said longitudinal fin is formed integrally with a pair of lateral fins adjacent to each other above and below in such a way as to couple said pair of lateral fins.

10. An air feed structure according to claim 3,
wherein said air blowing portion is disposed at a side portion of an instrument panel, and
wherein a fixing portion, which is to be fixed to a fixed portion disposed at said instrument panel, is disposed at a periphery of said convex portion of said air feed duct.

11. An air feed structure according to claim 4,
wherein said air blowing portion is disposed at a side portion of an instrument panel, and
wherein a fixing portion, which is to be fixed to a fixed portion disposed at said instrument panel, is disposed at a periphery of said convex portion of said air feed duct.
